(19) United States
(12) Patent Application Publication
(10) Pub. No.: US 2022/0140430 A1
(43) Pub. Date: May 5, 2022

(54) END PLATE SECURING STRUCTURE AND BATTERY DEVICE

(71) Applicant: HONDA MOTOR CO., LTD., Tokyo (JP)

(72) Inventors: Ryu TATE, Saitama (JP); Satoshi TAKADA, Saitama (JP)

(21) Appl. No.: 17/434,411

(22) PCT Filed: Feb. 27, 2019
(86) PCT No.: PCT/JP2019/007622

§ 371 Date: Aug. 27, 2021

(51) Int. Cl. H01M 50/264; H01M 50/209

(52) U.S. Cl. CPC H01M 50/264; H01M 50/209

(57) ABSTRACT

This end end plate securing structure comprises a battery case capable of housing a plurality of battery cells in a stacked state, and an end plate for pressing the plurality of battery cells in a stacking direction, and holds the plurality of battery cells in the battery case by securing the end plate to the battery case. The end plate has a recessed groove that is provided in an end surface, a securing member that is disposed in the recessed groove to be projectable from and retractable into the end surface, and a biasing member that is disposed in the recessed groove and biases the securing member in a projection direction. The battery case has an engagement part that engages with the securing member. The end plate is secured to the battery case by engagement of the securing member of the end plate with the engagement part.

### TECHNICAL FIELD

The present invention relates to a fastening structure of an end plate and a battery device.

### BACKGROUND ART

A hybrid car and an electric vehicle are equipped with a battery device including a plurality of battery cells such as lithium-ion secondary batteries. Normally, such a plurality of battery cells are stacked and housed in a battery case. By mounting such a battery case to the vehicle, a plurality of batteries are equipped to the vehicle.

Generally, the battery cells expand due to charging and discharging. Since the expansion of the battery cells leads to a decrease in the battery performance, conventionally, a plurality of battery cells in a stacked state are sandwiched between the end plates while being compressed, and these end plates are fastened by a binding bar disposed between the end plates, whereby the battery cells in the stacked state are constrained so as to suppress the expansion (for example, refer to Japanese Unexamined Patent Application, Publication No. 2012-181970).

Patent Document 1: Japanese Unexamined Patent Application, Publication No. 2012-181970

### DISCLOSURE OF THE INVENTION

### Problems to be Solved by the Invention

As is conventional, the structure for fastening the end plate to the binding bar requires a number of components, such as a binding bar and a fastening component for fastening the end plate to the binding bar. Since the battery device is configured by housing the battery cells constrained by the end plates and the binding bar in the battery case in this way, there is a problem of increase in size and weight, and thus, a reduction in weight and the number of parts of the battery device is desired.

An object of the present invention is to provide a fastening structure for an end plate capable of retaining a plurality of battery cells in a battery case by the end plate without being constrained by another member such as a binding bar, and a battery device.

### Means for Solving the Problems

A first aspect of the present invention is directed to a fastening structure of an end plate including: a battery case (for example, battery cases 2 and 5, described later) that can store a plurality of battery cells (for example, battery cells 31 described later) in a stacked state; and the end plate (for example, end plates 4 and 6 described later) that presses the plurality of battery cells in a stacking direction, the fastening structure being configured to fasten the end plate to the battery case, thereby holding the plurality of battery cells in the battery case, in which the end plate includes: a recessed groove (for example, recessed grooves 41 and 61 described later) provided on an end face (for example, long side end faces 4a and 6a described later) thereof; a fastening member (for example, fastening members 42 and 62 described later) which is disposed within the recessed groove in a projectable and retractable manner with respect to the end face; and a biasing member (for example, biasing members 43 and 63 described later) that is disposed within the recessed groove and biases the fastening member in a projecting direction, in which the battery case includes an engaging portion (for example, a fitting recess 25, and engaging portions 55 and 56 described later) that engages with the fastening member at a position corresponding to the fastening member of the end plate, and in which an engagement of the fastening member of the end plate with the engaging portion allows the end plate to be fastened to the battery case.

According to the fastening structure of the end plate described in the first aspect, by the fastening member which can project and retract from the end face of the end plate being engaged with the engaging portion of the battery case, the end plate is fastened to the battery case while pressing the battery cell in the stacking direction. Therefore, it is possible to hold the plurality of battery cells in the battery case by the end plate without being constrained by a separate member such as a binding bar.

According to a second aspect of the present invention, in the fastening structure of the end plate as described in the first aspect, the fastening member may have a plate shape, and the engaging portion may be a fitting recess (for example, a fitting recess 25 described later) that receives the fastening member, or a locking stepped portion (for example, locking stepped portions 55a and 56a) that locks the fastening member.

According to the fastening structure of the end plate as described in the second aspect, it is possible to fasten the end plate to the battery case with a simple structure.

According to a third aspect of the present invention, in the fastening structure of the end plate as described in the first or second aspect, the battery case may be a square tubular-shaped case including a horizontally elongated rectangular opening (for example, an opening 24 described later) at both ends thereof in the stacking direction of the plurality of battery cells, and the end plate may be fastened to be fit in the opening of the battery case.

According to the fastening structure of the end plate as described in the third aspect, it is possible to hold a plurality of battery cells in the battery case by fastening the end plate to the opening of the battery case.

According to a fourth aspect of the present invention, in the fastening structure of the end plate as described in the third aspect, the end plate may have a horizontally elongated rectangular plate shape, and include two long side end faces (for example, a long side end face 4a described later) and two short side end faces (for example, a short side end face 4b described later), and the fastening member may be disposed on at least one of the two long side end faces, and extend along a length direction of the long side end face.

According to the fastening structure of the end plate as described in the fourth aspect, since the fastening member is disposed on the long side end face of the end plate and extends along the length direction thereof, the force resisting the counterforce from the battery cell is strong, and it is possible to effectively hold the battery cell while suppressing the counterforce of the battery cell by the end plate.

According to a fifth aspect of the present invention, in the fastening structure of the end plate as described in the fourth aspect, at least one of a side edge of the fastening member close to the battery cell or an inner side edge of the opening may have a chamfered portion (for example, chamfered portions 422 and 261 described later).

According to the fastening structure of the end plate as described in the fifth aspect, since it is possible to guide the fastening member smoothly in a direction to retract the fastening member by the chamfered portion when the fastening member is in contact with the opening of the battery case, it is possible to fasten the end plate to the battery case while pressing the battery cell in a direction to compress the battery cell.

According to a sixth aspect of the present invention, in the fastening structure of the end plate as described in the first or second aspect, the battery case may include a rectangular bottom plate portion(for example, a bottom plate portion 51 described later), and side plate portions (for example, side plate portions 52 and 53) which are provided in a standing manner from four circumferences of the bottom plate portion, and may have a bathtub-shape which is only open upward, and the end plate may be fastened on an inner face of the battery case.

According to the fastening structure of the end plate as described in the sixth aspect, it is possible to hold the plurality of battery cells in the battery case by fastening the end plate within the battery case.

According to a seventh aspect of the present invention, in the fastening structure of the end plate as described in the sixth aspect, the end plate may have a horizontally elongated rectangular plate shape, and include two long side end faces and two short side end faces, and the fastening member may include a plurality of fastening members which are respectively disposed on one of the long side end faces corresponding to the bottom plate portion and two of the short side end faces, and extend along the length directions of the long side end face and the short side end faces.

According to the fastening structure of the end plate as described in the seventh aspect, since the end plate is fastened to the battery case at three faces among the four peripheral end faces of the end plate, the force resisting the counterforce from the battery cell is strong, and thus, it is possible to effectively hold the battery cell while suppressing the counterforce of the battery cell by the end plate.

According to an eighth aspect of the present invention, in the fastening structure of the end plate as described in one of the first to seventh aspects, the end plate may include a regulating means (for example, a groove 431 and a pin 44 described later) that regulates a movement range of the fastening member in a projecting direction.

According to the fastening structure of the end plate as described in the eighth aspect, since the movement range of the projecting and retracting direction of the fastening member is restricted, the fastening member is prevented from escaping from the groove.

According to a ninth aspect of the present invention, in the fastening structure of the end plate as described in the eighth aspect, the regulating means may be disposed on a side opposite to the battery cell within the battery case with respect to the fastening member.

According to the fastening structure of the end plate as described in the ninth aspect, when the counterforce of the battery cell acts on the fastening member, it is possible to prevent the regulating means from being affected.

A tenth aspect of the present invention is directed to a battery device (for example, battery devices 1 and 1A described later) including: a plurality of battery cells (for example, battery cells 31 described later); a battery case (for example, battery cases 2 and 5 described later) that stores the plurality of battery cells in a stacked state; and an end plate (for example, end plates 4 and 6 described later) that is fastened to the battery case, and presses and holds the plurality of battery cells in a stacking direction, and the battery device further includes the fastening structure of the end plate according to any one of the first to ninth aspects.

According to the battery device as described in the tenth aspect, by the fastening member which can project and retract from the end face of the end plate being engaged with the engaging portion of the battery case, the end plate is fastened to the battery case while pressing the battery cell in the stacking direction. Therefore, it is possible to hold the plurality of battery cells in the battery case by the end plate without being constrained by a separate member such as a binding bar.

### Effects of the Invention

According to the present invention, it is possible to provide a fastening structure for an end plate capable of retaining a plurality of battery cells in a battery case by the end plate without being constrained by another member such as a binding bar, and a battery device.

### BRIEF DESCRIPTION OF THE DRAWINGS

FIG. 1 is a perspective view showing a first embodiment of a battery device;

FIG. 2 is an exploded perspective view of an end plate of the first embodiment;

FIG. 3 is a cross-sectional view of the battery device of the first embodiment taken along the line A-A in FIG. 2;

FIG. 4 is an enlarged perspective view of a main portion of a fastening member of the end plate of the first embodiment;

FIG. 5 is an enlarged cross-sectional view of the main portion of the end plate of the first embodiment;

FIG. 6 is a diagram for explaining a state of attaching the end plate of the first embodiment to a battery case;

FIG. 7 is a diagram for explaining a state in which a counterforce from a battery cell acts on the end plate of the first embodiment;

FIG. 8 is a perspective view showing a second embodiment of the battery device;

FIG. 9 is a perspective view of an end plate of the second embodiment;

FIG. 10 is a vertical cross-sectional view of the end plate shown in FIG. 9 taken along the width direction;

FIG. 11 is a cross-sectional view taken along the line B-B in FIG. 10;

FIG. 12 is a cross-sectional view taken along the line C-C in FIG. 10;

FIG. 13 is a perspective view showing an enlarged main part of the battery device shown in FIG. 8;

FIG. 14 is a horizontal cross-sectional view showing an enlarged fastening portion of one end plate in the battery device shown in FIG. 8; and

FIG. 15 is a vertical cross-sectional view showing an enlarged fastening portion of one end plate in the battery device shown in FIG. 8.

### PREFERRED MODE FOR CARRYING OUT THE INVENTION

Embodiments of the present invention will be described below with reference to the drawings.

### First Embodiment

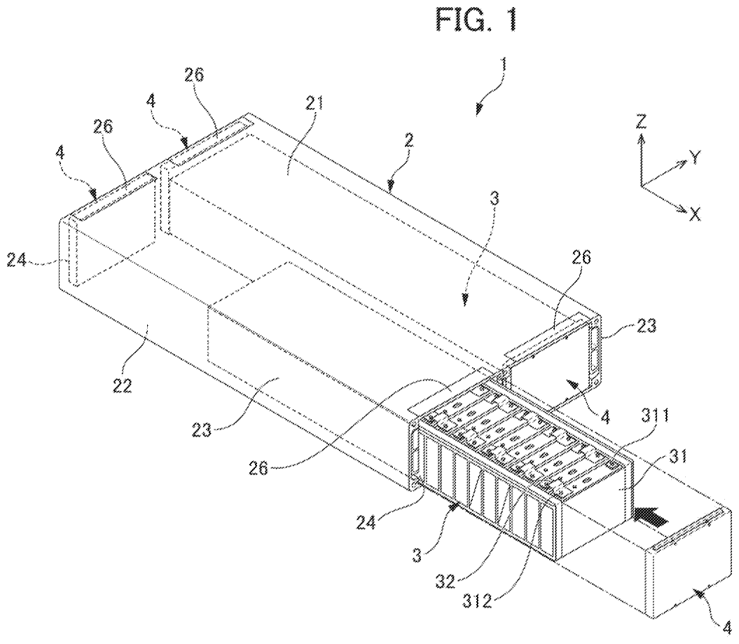

FIG. 1 is a perspective view showing a first embodiment of a battery device. As shown in FIG. 1, the battery device 1 of the present embodiment includes a battery case 2, a battery cell group 3 housed in the battery case 2, and an end plate 4 fastened to the battery case 2 housing the battery cell group 3. It should be noted that, regarding the directions in the drawings, the X direction indicates the length direction of the battery device 1 (battery case 2), the Y direction indicates the width direction of the battery device 1 (battery case 2), and the Z direction indicates the height direction of the battery device 1 (battery case 2).

The battery case 2 is made of a metal such as aluminum or aluminum alloy, and is formed in a substantially square tubular shape having an upper wall portion 21, a lower wall portion 22, and side wall portions 23 and 23. The battery case 2 is formed to be elongated along the X direction, and includes horizontally elongated rectangular openings 24 and 24 respectively provided on both end faces of the battery case 2 in the X direction. The battery case 2 has the same shape in cross section along the X direction, and thus, it is possible to easily mold the battery case 2 by extrusion molding with the X direction as the extrusion direction.

The battery cell group 3 includes a plurality of battery cells 31 each in a substantially rectangular parallelepiped shape in a stacked manner along the X direction. The battery cells 31 each include a pair of positive and negative electrode terminals 311 and 312 on the upper face thereof. The electrode terminals 311 and 312 of the battery cells 31 and 31 adjacent to each other in the X direction are electrically coupled to each other by a bus bar 32. Thus, the battery cells 31 of the battery cell group 3 are connected in series or in parallel. In the present embodiment, the two battery cell groups 3 and 3 are inserted into any of the openings 24 of the battery case 2 along the stacking direction of the battery cells 31, and are housed in parallel in the battery case 2.

The end plate 4 is a plate-shaped member made of a metal such as aluminum, an aluminum alloy, or iron. The end plate 4 of the present embodiment is formed in a horizontally elongated rectangular shape which is substantially equal to the shape of the side face shape of the battery cell 31 and the opening shape of the opening 24 of the battery case 2 facing in the X direction. Two of four end plates 4 are provided for each of the battery cell groups 3 and 3 on the opposite end faces in the X direction so as to sandwich the battery cell group 3. Two of the four end plates 4 are provided in a parallel manner for one opening 24 of the battery case 2, and are respectively fit and fastened to the opening 24.

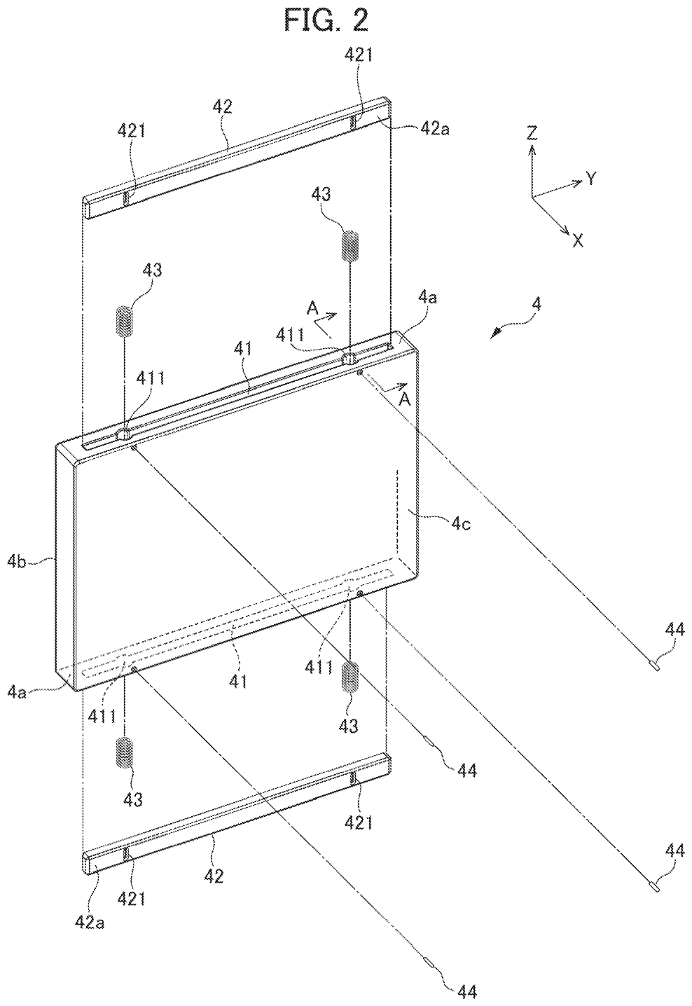

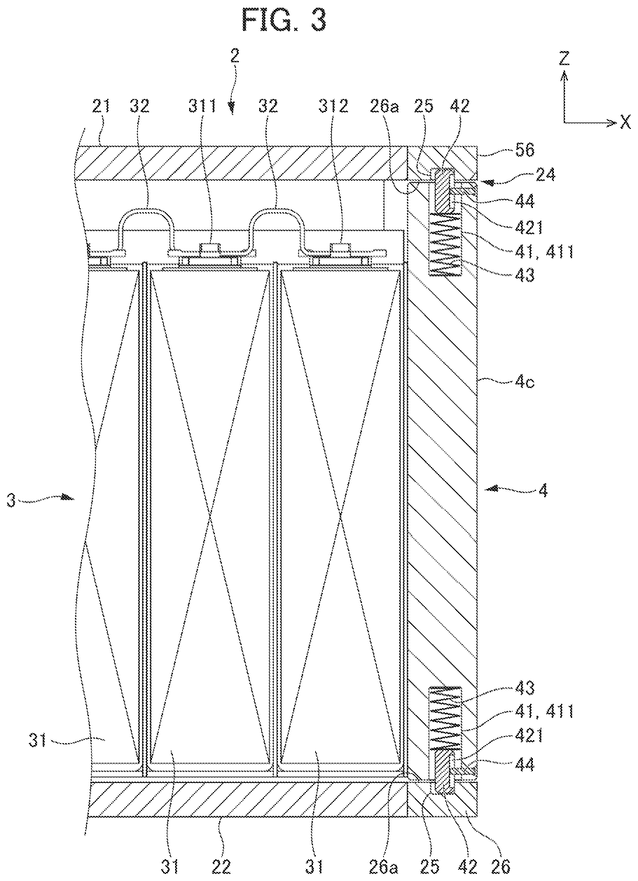

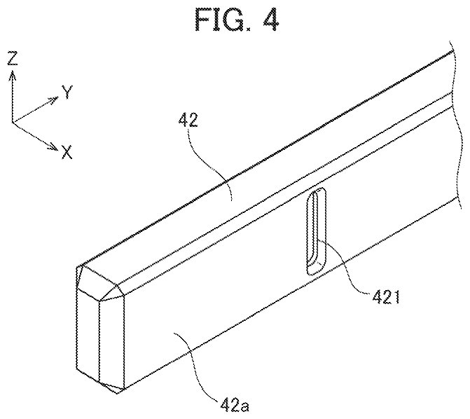

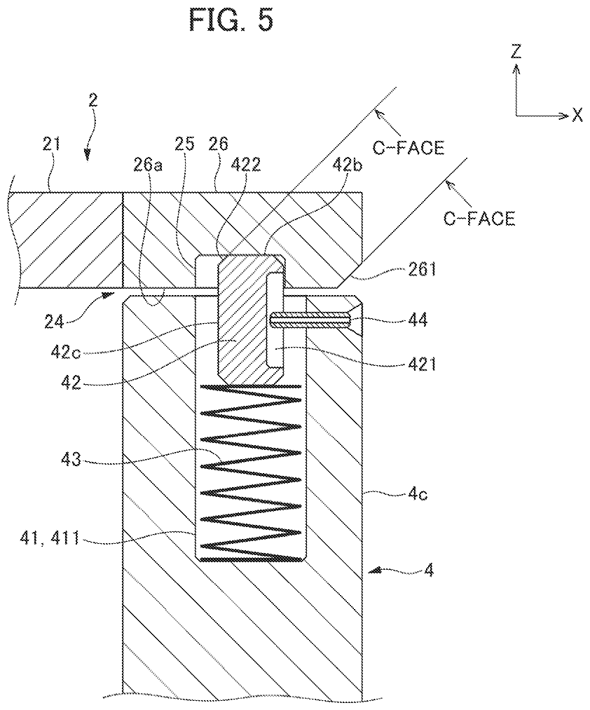

The specific fastening structure of the end plate 4 will be described with reference to FIGS. 2 to 5. FIG. 2 is an exploded perspective view of the end plate. FIG. 3 is a cross-sectional view of a battery device taken along the line A-A in FIG. 2. FIG. 4 is an enlarged perspective view of a main portion of the fastening member of the end plate. FIG. 5 is an enlarged cross-sectional view of a main portion of the end plate.

The end plate 4 includes long side end faces 4a and 4a provided above and below, and short side end faces 4b and 4b provided on the left and right. The end plate 4 further includes, on the respective long side end faces 4a and 4a provided above and below among the end faces over these four sides, recessed grooves 41, fastening members 42 provided respectively in the recessed grooves 41, and biasing members 43 provided respectively in the recessed grooves 41.

The recessed grooves 41 are respectively provided so as to extend to be long in the width direction of the end plate 4 on the upper and lower long side end faces 4a and 4a of the end plate 4. The recessed groove 41 has a depth to the extent that can completely house the fastening member 42 so as not to allow the fastening member 42 to protrude from the long side end face 4a. The recessed groove 41 includes biasing member housing portions 411 and 411 provided in the vicinity of the both ends in the length direction. The biasing member housing portions 411 and 411 are recessed slightly wider, and each have a circular shape in the plan view. The biasing members 43 and 43 are each made of, for example, a coil spring, and housed in the biasing member housing portions 411 and 411 in the recessed groove 41 so that the biasing direction corresponds to the depth direction of the recessed groove 41.

The fastening member 42 is a member for fastening the end plate 4 to the battery case 2, and is formed of a metal material such as iron. The fastening members 42 are each housed in the recessed groove 41 in a projectable and retractable manner along the Z direction from the long side end face 4a of the end plate 4. Similarly to the recessed groove 41, the fastening member 42 of the present embodiment is made of a key member having a horizontally elongated rectangular plate shape which is formed to extend to be long in the width direction of the end plate 4. The biasing members 43 are provided between a groove bottom of the recessed groove 41 and the fastening member 42 so as to bias the fastening member 42 in a direction to protrude from the long side end face 4a.

The fastening member 42 has two grooves 421 and 421. The grooves 421 and 421 are provided in the fastening member 42 so as to respectively correspond to installation positions of the biasing members 43 and 43 on one side face 42a of side faces orthogonal to the long side end face 4a of the end plate 4. The side face 42a refers to a side face provided so as to face outward when the end plate 4 is fastened to the battery case 2, and thus, refers to a side face opposite to the side of the battery cell group 3 in the battery case 2. As shown in FIG. 4, the grooves 421 and 421 each extend vertically along the biasing direction of the biasing member 43, i.e., along the projecting and retracting movement direction of the fastening member 42 (Z direction). In a state in which the fastening member 42 is housed in the recessed groove 41, at least a portion of each of the grooves 421 and 421 is disposed inside the recessed groove 41.

In the recessed groove 41, at a position corresponding to the groove 421 and 421 of the fastening member 42, pins 44 and 44 are provided. The pin 44 of the present embodiment is formed of a rod-shaped body having a width narrower than the width of the groove 421. The pins 44 and 44 are each fastened to the end plate 4 by being penetrated so as to protrude into the recessed groove 41 from a side face 4c of the end plate 4 facing the same side as the side face 42a of the groove 421 and 421 of the fastening member 42.

Tips of the pins 44 and 44 each facing the recessed groove 41 are housed in the grooves 421 and 421 of the fastening member 42, and are engaged with the respective grooves 421 and 421. As a result, the movement range of the fastening member 42 in the projecting and retracting direction (Z direction) is regulated to the range corresponding to the length of the grooves 421 and 421 by the contact between the tips of the pins 44 and 44 and the upper end or the lower end of the grooves 421 and 421. In other words, the groove 421 of the fastening member 42 and the pin 44 configure a regulating means for regulating the movement range in the projecting and retracting direction of the fastening member 42.

For example, when the tips of the pins 44 and 44 are brought into contact with the lower ends of the groove 421 and 421, further movement in the projecting direction of the fastening member 42 is restricted. This prevents the fastening member 42 from coming out of the recessed groove 41. Further, when the tips of the pins 44 and 44 are brought into contact with the upper ends of the groove 421 and 421, further movement of the retracting direction of the fastening member 42 is restricted. This prevents the fastening member 42 from excessively compressing the biasing member 43.

As shown in FIG. 5, the fastening member 42 includes a chamfered portion 422 provided by cutting the corner so as to be sloped obliquely at the side edge of the end face 42b facing the projecting side from the recessed groove 41. The side edge on which the chamfered portion 422 is provided at the end face 42b includes at least a side edge which is disposed on the side of the battery cell 31 (the interior side of the battery case 2) when the end plate 4 is fitted into the opening 24 of the battery case 2. The chamfered portion 422 is provided over the entire length in the length direction of the fastening member 42.

As shown in FIG. 3, the opening 24 of the battery case 2 includes a fitting recess 25. The fitting recess 25 is provided at a position corresponding to the fastening member 42 of the end plate 4 when the end plate 4 is fitted into the opening 24. Since the fastening members 42 of the present embodiment are provided so as to protrude from the upper and lower long side end faces 4a and 4a of the end plate 4, the fitting recess 25 is provided such that the fastening members 42 and 42 of the end plate 4 can be received at the inner faces of the upper wall portion 21 and the lower wall portion 22 at the opening 24 of the battery case 2.

The fitting recess 25 of the present embodiment is a horizontally long key groove corresponding to the fastening member 42 made of a horizontally elongated rectangular plate-shaped key member. Since fitting of the fastening member 42 with respect to the fitting recess 25 forms a fitting structure of the key member and the key groove, it is possible to fasten the end plate 4 to the battery case 2 with a simple structure.

The battery case 2 of the present embodiment includes edge members 26 which are separate members from the battery case 2, at portions corresponding to the openings 24 of the upper wall portion 21 and the lower wall portion 22. The edge members 26 are each formed of a metal material such as iron having higher rigidity than the battery case 2. The edge members 26 are provided at the respective peripheries of the openings 24 corresponding to the upper and lower long side end faces 4a and 4a of each of the end plates 4 at the upper wall portion 21 and the lower wall portion 22. The fitting recesses 25 are each provided on an inner face 26a of the edge member 26. With such a configuration, the fitting of the fastening member 42 of the end plate 4 and the fitting recess 25 can be performed with metal materials having higher rigidity than the battery case 2. Therefore, it is possible to improve the load carrying capacity and durability of the fitting portion between the fastening member 42 and the fitting recess 25.

As shown in FIG. 5, the battery case 2 includes a chamfered portion 261 provided by cutting the corner so as to be sloped obliquely, similar to the chamfered portion 422 of the fastening member 42, at the inner side edge of the opening 24. In the present embodiment, the chamfered portion 261 is provided at an inner opening edge corresponding to the fastening member 42 of the end plate 4 for each of the edge members 26 and 26 of the upper wall portion 21 and the lower wall portion 22. The respective faces (C-faces) of the chamfered portion 422 of the fastening member 42 and the chamfered portion 261 of the battery case 2 have a substantially equal angle. It should be noted that FIG. 5 shows only the upper portion of the end plate 4; however, since the end plate 4 of the present embodiment is a vertically symmetrical structure, the lower portion of the end plate 4 also has a vertically symmetrical structure with respect to FIG. 5.

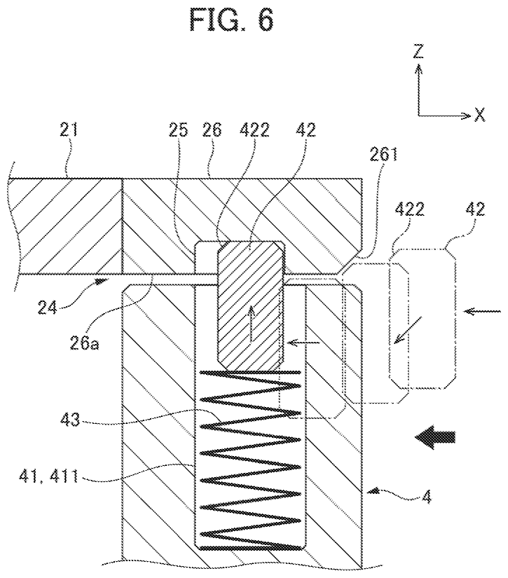

Next, a method of fastening the end plate 4 to the battery case 2 will be further described with reference to FIG. 6. FIG. 6 is a diagram showing a state of attaching the end plate to the battery case. It should be noted that, although the lower portion of the end plate 4 is not shown in FIG. 6, since the end plate 4 of the present embodiment has a vertically symmetrical structure, the lower portion of the end plate 4 is also fastened in the same manner as in FIG. 6.

The fastening member 42 of the end plate 4 before fastening projects from the long side end face 4a within the movement range restricted by the groove 421 and the pin 44 by the biasing force of the biasing member 43. The dimension in the height direction of the end plate 4 including the upper and lower fastening members 42 and 42 at this time is slightly larger than the inner dimension in the height direction of the opening 24 of the battery case 2.

First, the end plate 4 is provided so as to be brought into contact with the end face of the battery cell group 3 housed in the battery case 2. Thereafter, the end plate 4 is moved in a translational motion so as to press toward the opening 24 so as to compress the battery cell group 3 in the stacking direction of the battery cells 31. At this time, the other end face of the battery cell group 3 in the stacking direction of the battery cells 31 is in contact with the end plate 4 which is fastened in advance to the other opening of the battery case 2 as shown in FIG. 1.

When the end plate 4 is pushed to the opening 24 of the battery case 2, the fastening member 42 is brought into contact with the inner peripheral edge of the opening 24 of the battery case 2, as shown in a dot-dash line in FIG. 6. At this time, the chamfered portion 422 of the fastening member 42 is in contact with the chamfered portion 261 of the opening 24, and thus, the fastening member 42 is pushed gradually into the recessed groove 41 in the retracting direction against the biasing force of the biasing member 43, while being smoothly guided by the C-faces of the chamfered portions 422 and 261.

When the fastening member 42 is pushed so as to be substantially fully retracted into the recessed groove 41, the end plate 4 is fitted inside the opening 24 of the battery case 2. Thereafter, when the end plate 4 is pushed until the fastening member 42 is inserted into the position of the fitting recess 25 of the battery case 2, as shown in FIG. 6, the fastening member 42 protrudes from the recessed groove 41 by the biasing force of the biasing member 43 and snaps (clicks) in the fitting recess 25.

Thus, the end plate 4 is fastened to the opening 24 of the battery case 2. Even if the counterforce from the battery cell group 3 acts on the end plate 4, the fitting of the fastening member 42 and the fitting recess 25 prevents the end plate 4 from moving outwardly. Therefore, the end plate 4 is no longer disengaged from the opening 24, and thus, it is possible to hold the battery cell group 3 in the battery case 2 in a compressed and constrained state.

Therefore, simply by moving the end plate 4 while pressing the battery cell group 3 in the stacking direction of the battery cell 31, and fitting the fastening member 42 to the fitting recess 25 of the battery case 2, it is possible to easily hold the battery cell group 3 within the battery case 2 by sandwiching the battery cell group 3 between the end plates 4 and 4. Since a separate member such as a binding bar for constraining the battery cell group 3 is not necessary, the number of parts is also reduced, and it is possible to suppress an increase in the size and weight of the battery device 1.

When the chamfered portion 422 of the fastening member 42 and the chamfered portion 261 of the opening 24 are in contact with each other, the fastening member 42 of the end plate 4 is guided by the C-face and smoothly retracted within the recessed groove 41. Therefore, it is possible to fasten the end plate 4 to the battery case 2 only by moving the end plate 4 laterally in a translational motion along the stacking direction of the battery cell 31, a result of which workability is improved. It suffices if the chamfered portion is provided only on either the fastening member 42 or the opening 24.

In the present embodiment, the fastening member 42 of the end plate 4 is disposed on the long side end face 4a of the end plate 4, and extends to be long along the length direction of the end plate 4. Therefore, the force to resist the counterforce from the battery cell group 3 is strong. Because the counterforce from the battery cell group 3 is to act to bend the long side with respect to the end plate 4. Thus, the end plate 4 can effectively hold the battery cell group 3 by suppressing the counterforce of the battery cell group 3.

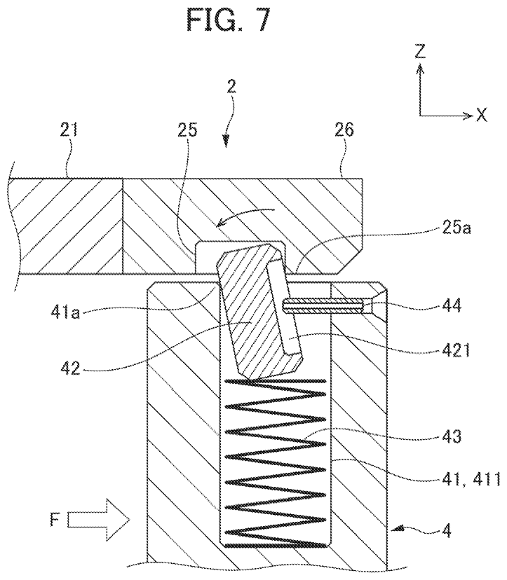

As shown in FIG. 7, when the counterforce F from the battery cell group 3 acts on the end plate 4, the end plate 4 is pressed so as to project toward the outside of the battery case 2. Thus, the fastening member 42 is brought into contact with the outer edge corner portion 25a of the fitting recess 25, and tries to tilt toward the inside of the battery case 2. At this time, by the fastening member 42 being brought into contact with the side of the inner edge corner portion 41a of the recessed groove 41, a large stress acts on the inner portion of the end plate 4 which is located on the inner side more than the fastening member 42. However, since the pin 44 is disposed on the side opposite to the battery cell group 3 with respect to the fastening member 42, even if the counterforce F of the battery cell group 3 acts on the fastening member 42, the influence of stress on the pin 44 is avoided.

It should be noted that the end plate 4 of the present embodiment is provided with the fastening members 42 and 42 on the upper and lower long side end faces 4a and 4a, respectively; however, for example, the lower long side end face 4a may be provided with a non-movable protrusion instead of the fastening member 42. In this case, the protrusion on the lower side of the end plate can be fastened to the battery case 2 by first inserting the protrusion into the fitting recess 25 on the lower side, and then moving the upper side of the end plate so as to rotate about the protrusion as a fulcrum. Furthermore, the fastening member 42 may be provided on the short side end face 4b of the end plate 4. Furthermore, the fastening member 42 may be provided on each of the three sides or more end faces including the long side end face 4a and the short side end face 4b of the end plate 4.

Furthermore, the end plate 4 having the above-described fastening structure may be at least one of two end plates respectively disposed on both end faces of the battery cell group 3. Therefore, the other end plate may be detachably fastened in advance by another fastening structure or may be non-detachably fastened to the battery case 2 before the battery cell group 3 is housed in the battery case 2, for example.

The battery cell group 3 housed in the battery case 2 of the present embodiment is not limited to two rows. Only one row of battery cell groups 3 may be housed in the battery case 2, or three or more rows of battery cell groups 3 may be housed in parallel. Furthermore, one end plate 4 may hold two or more battery cell groups 3 in the battery case 2 by pressing them in common.

### Second Embodiment

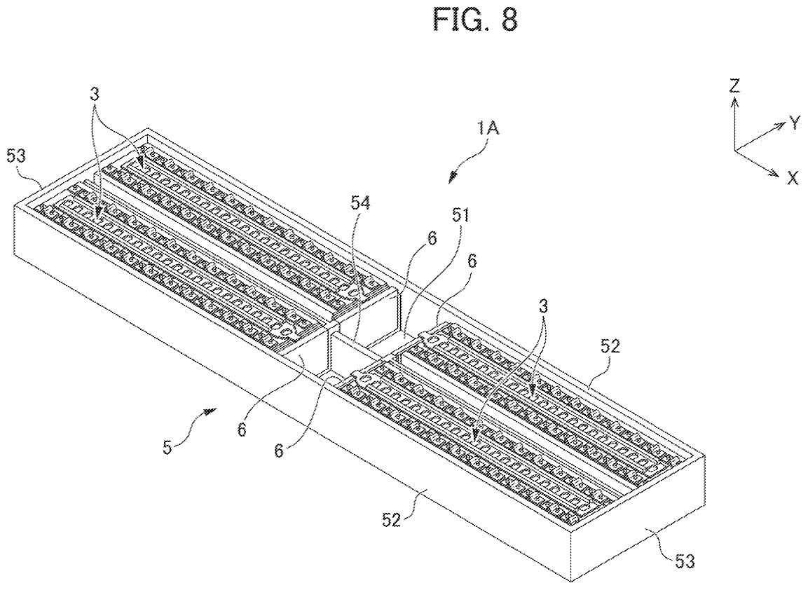

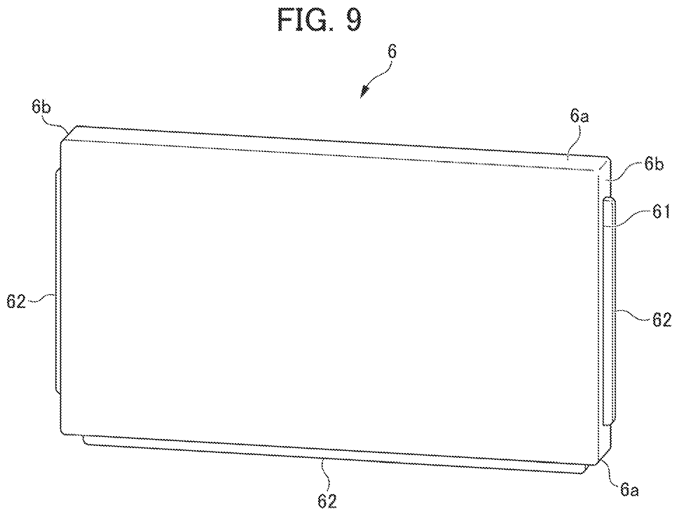

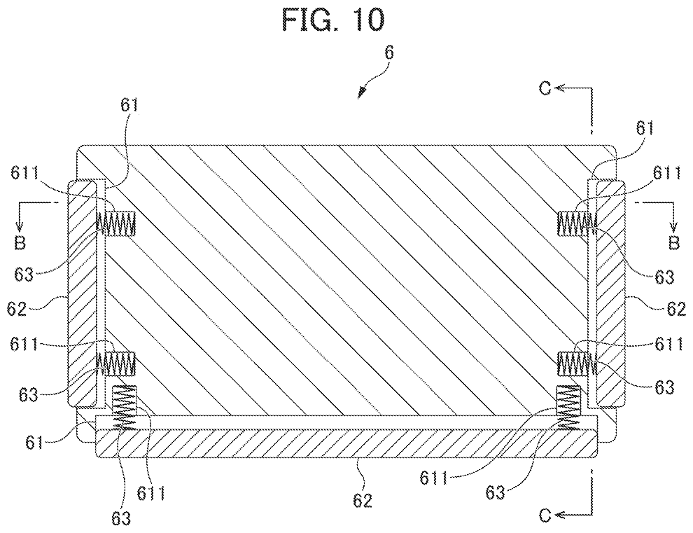

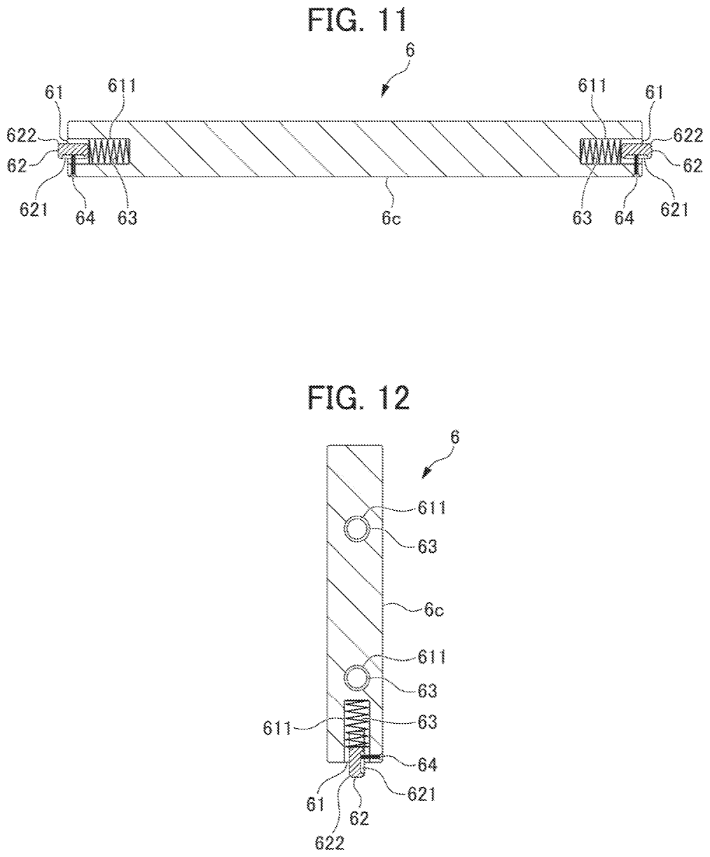

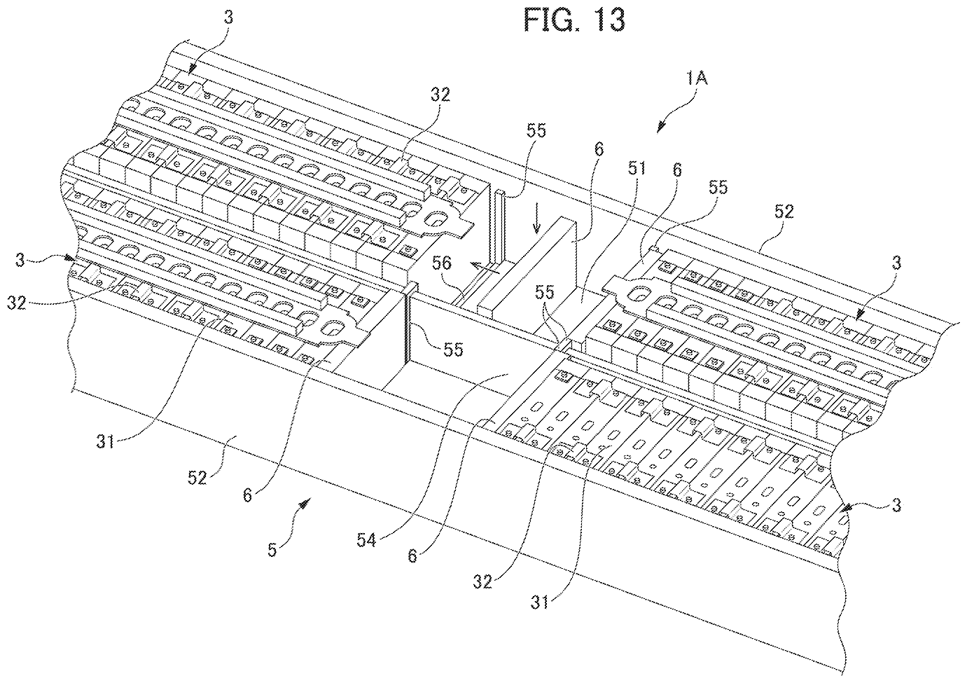

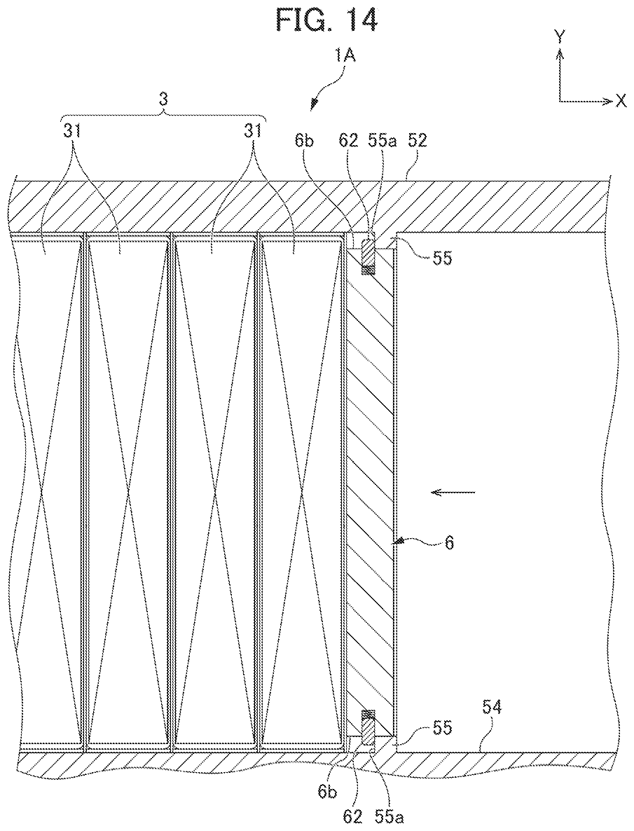

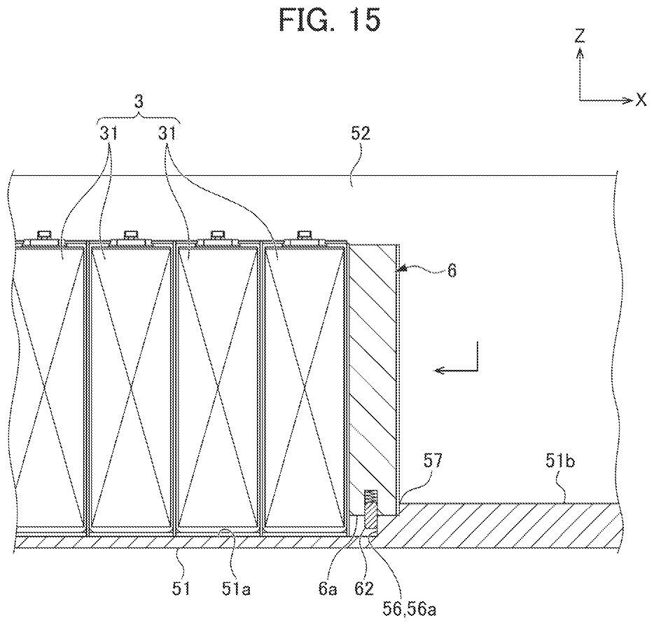

FIG. 8 is a perspective view showing a second embodiment of a battery device. FIG. 9 is a perspective view of an end plate of the second embodiment. FIG. 10 is a vertical cross-sectional view of the end plate shown in FIG. 9 taken along the width direction. FIG. 11 is a cross-sectional view taken along the line B-B in FIG. 10. FIG. 12 is a cross-sectional view taken along the line C-C in FIG. 10. FIG. 13 is a perspective view showing an enlarged main part of the battery device shown in FIG. 8. FIG. 14 is a horizontal cross-sectional view showing an enlarged fastening portion of one end plate in the battery device shown in FIG. 8. FIG. 15 is a vertical cross-sectional view showing an enlarged fastening portion of one end plate in the battery device shown in FIG. 8. Since parts having the same reference numerals as the battery device 1 of the first embodiment indicate parts having the same configuration, for detailed explanations thereof, the above description is invoked, and omitted here.

The battery device lA according to the second embodiment includes a battery case 5, a battery cell group 3 housed in the battery case 5, and an end plate 6 fastened in the battery case 5 housing the battery cell group 3. The battery case 5 of the present embodiment includes a rectangular bottom plate portion 51, and side plate portions 52 and 53 which are erected in a standing manner from the four circumferences of the bottom plate portion 51, and has a bathtub-shape which is only open upward. These aspects of the second embodiment differ from the substantially square tubular battery case 2 of the first embodiment. The battery case 5 includes a lid member (not shown) on a top face thereof.

The battery case 5 includes a partition wall portion 54 extending along the length direction (X direction) at the central portion in the width direction (Y direction). The interior of the battery case 5 is divided into two in the width direction by the partition wall portion 54. The battery case 5 houses two battery cell groups 3 in each housing portion partitioned by the partition wall portion 54.

The end plates 6 are each provided on the side close to the central portion in the length direction of the battery case 5, and disposed such that each of the battery cell groups 3 presses toward the side plate portions 53 and 53 of both end portions in the length direction of the battery case 5. In the present embodiment, four end plates 6 are provided so as to correspond to the respective four battery cell groups 3. As described later in detail, each of the end plates 6 is disposed so as to be erected in a standing manner from the bottom plate portion 51 of the battery case 5, and is fastened to the three faces including one of the side plate portions 52 of the battery case 5, the partition wall portion 54 and the bottom plate portion 51.

Similarly to the end plate 4 of the first embodiment, the end plate 6 of the present embodiment is a plate-shaped member made of a metal such as aluminum, aluminum alloy or iron, and has a horizontally elongated rectangular shape substantially equal to the side face shape of the battery cell 31 facing in the X direction. Similarly to the end plate 4 of the first embodiment, the specific fastening structure of the end plate 6 includes a fastening member 62, a biasing member 63, and a biasing member housing portion 611 in the recessed groove 61. The fastening member 62, the biasing member 63, and the biasing member housing portion 611 have the same configurations as the fastening member 42, the biasing member 43, and the biasing member housing portion 411 of the end plate 4 of the first embodiment.

In the end plate 6, the recessed groove 61 is provided on each of the three end faces including the lower long side end face 6a and the left and right short side end faces 6b and 6b among the four end faces of the end plate 6, and each extends along the length directions of the long side end face 6a and the short side end faces 6b and 6b. The fastening member 62 made of a plate-shaped key member is disposed in the three recessed grooves 61, respectively, and is biased in a direction protruding from the recessed groove 61 by the biasing member 63 which is housed in the respective biasing member housing portions 611.

As shown in FIG. 11 and FIG. 12, similarly to the groove 421 and the pin 44 of the fastening member 42 of the first embodiment, the fastening member 62 includes two grooves 621 and two pins 64 constituting the regulating means for regulating the movement range in the projecting and retracting direction of the fastening member 62. The pin 64 is penetrated toward the groove 621 from the side face 6c of the end plate 6 facing the same side on which the groove 621 of the fastening member 62 is disposed. The side face 6c is opposite to the contact face of the battery cell group 3 in the end plate 6. Furthermore, each of the fastening members 62 has a chamfered portion 622 which is similar to the chamfered portion 422 of the fastening member 42 of the first embodiment.

On the other hand, the battery case 5 includes engaging portions 55 and 56 for engaging the fastening member 62 of the end plate 6 over the three faces of the end plate 6 including the inner face of each of the side plate portions 52 and 52, the inner face of the bottom plate portion 51, and both side faces of the partition wall portion 54. The engaging portion 55 extends in the vertical direction (depth direction) in the battery case 5, and is disposed on the inner face of each of the side plate portions 52 and 52, and both sides of the partition wall portion 54. The engaging portion 56 extends in the lateral direction (width direction) in the battery case 5, and is disposed on the inner face of the bottom plate portion 51. These engaging portions 55 and 56 are disposed in the vicinity of the inner side face (the side opposite to the side plate portion 53) of the battery cell group 3 in the battery case 5.

More specifically, the engaging portion 55 extending in the vertical direction is formed by a protrusion protruding inward from the inner face of each of the side plate portions 52, 52 and both side faces of the partition wall portion 54. The side face on the side of the battery cell group 3 in the engaging portion 55 made of this protrusion constitutes locking stepped portions 55a for locking the fastening members 62 and 62 disposed on the left and right short side end faces 6b and 6b of the end plate 6. As shown in FIG. 14, the distance between the side plate portion 52 and the partition wall portion 54 is slightly larger than the length in the width direction of the end plate 6 including the fastening member 62. However, the distance between the tip face of the engaging portion 55 of the side plate portion 52 and tip face of the engaging portion 55 of the partition wall portion 54 has substantially the same length as the length in the width direction of the end plate 6 except for the fastening member 62.

Furthermore, as shown in FIG. 15, the engaging portion 56 extending in the lateral direction is formed by making the inner face 51a of the region where the battery cell group 3 is placed in the inner face of the bottom plate portion 51 deeper than the inner face 51b of the region of the central portion in the length direction of the battery case 5. The engaging portion 56 constitutes the locking stepped portion 56a for locking the fastening member 62 disposed on the lower long side end face 6a of the end plate 6.

As shown in FIG. 15, the inner face of the battery case 5 includes a lower end of a housing stepped portion 57 for housing the lower end of the end plate 6 by coming into contact with the long side end face 6a of the lower side of the end plate 6 between the engaging portion 56 and the inner face 51b of the region of the central portion of the battery case 5. The housing stepped portion 57 is formed by making a part between the engaging portion 56 and the inner face 51b of the region of the central portion of the battery case 5 slightly lower than the inner face 51b and higher than the inner face 51a. The housing stepped portion 57 is disposed at a position continuous with the lower end of the engaging portions 55 and 55 in the length direction, and houses an end face provided opposite to the battery cell group 3 and across the fastening member 62 on the lower long side end face 6a.

Next, a method of fastening the end plate 6 to the battery case 5 will be described. As shown in FIG. 13, the end plate 6 is inserted between the side plate portion 52 and the partition wall portion 54 from above the central portion in the length direction of the battery case 5, while causing the fastening member 62 disposed on the lower long side end face 6a to face the bottom plate portion 51. At this time, the fastening members 62 and 62 disposed on the left and right short side end faces 6b and 6b of the end plate 6 project from the end plate 6 by the biasing force of the biasing member 63. On the other hand, the fastening member 62 disposed on the long side end face 6a of the end plate 6 is retracted within the recessed groove 61 by the end plate 6 being pressed against the inner face 51b of the bottom plate portion 51 at the central portion in the length direction of the battery case 5. Thus, the long side end face 6a of the lower side of the end plate 6 is in direct contact with the inner face 51b.

The end plate 6 inserted into the central portion in the length direction of the battery case 5 is moved in parallel toward the battery cell group 3 while maintaining its posture, and eventually comes into contact with the side face of the battery cell group 3. When the end plate 6 comes into contact with the battery cell group 3, each of the fastening member 62 of the end plate 6 is not yet engaged with the engaging portions 55 and 56. By further moving the end plate 6 in a translational motion toward the battery cell group 3 after the contact, the battery cell group 3 is compressed in the stacking direction of the battery cells 31.

By the end plate 6 being further moved in a translational motion, the fastening members 62 and 62 disposed on the left and right short side end faces 6b and 6b of the end plate 6 are brought into contact with the engaging portions 55 and 55 in the vertical direction, and pressed by the engaging portions 55 and 55, whereby the fastening members 62 and 62 are gradually retracted into the recessed groove 61 and 61. Thereafter, when the fastening members 62 and 62 pass through the engaging portions 55 and 55, the fastening members 62 and 62 project again between the engaging portions 55 and 55 and the battery cell group 3 by the biasing force of the biasing member 63. As a result, as shown in FIG. 14, the fastening members 62 and 62 snap (click) in the locking stepped portion 55a constituted by the engaging portion 55 for locking.

On the other hand, the fastening member 62 disposed on the long side end face 4a of the lower side of the end plate 6 projects again between the engaging portion 56 and the battery cell group 3 by the biasing force of the biasing member 63 when passing through the engaging portion 56 in the lateral direction. As a result, the fastening member 62 snaps (clicks) in the locking stepped portion 56a constituted by the engaging portion 56 for locking. Furthermore, as shown in FIG. 15, the long side end face 6a of the lower side of the end plate 6 is in contact with the housing stepped portion 57, and housed.

Thus, the end plate 6 is fastened in the battery case 5. Even if a counterforce from the battery cell group 3 acts on the end plate 6, the engagement of the three fastening members 62 with the respective engaging portions 55 and 56 prevents the outward movement of the end plate 6. Therefore, the end plate 6 does not deviate from the engaging portions 55 and 56, and thus, it is possible to hold the battery cell group 3 in the battery case 5 in a state of being compressed and constrained. Moreover, since the end plate 6 is fastened to the battery case 5 by three faces among the four peripheral end faces 4a, 4a, 4b, and 4b, the force resisting the counterforce from the battery cell 31 is strong, and thus, it is possible to suppress the counterforce of the battery cell 31 by the end plate 6 and effectively hold the battery cell group 3.

Therefore, with the battery device 1A, it is possible to easily hold the battery cell group 3 within the battery case 5 by holding the battery cell group 3 between the end plate 6 and the side plate portion 53 simply by moving the end plate 6 while pushing the battery cell group 3 in the stacking direction of the battery cell 31 to engage the fastening member 62 with the engaging portions 55 and 56 of the battery case 5. Since a separate member such as a binding bar for constraining the battery cell group 3 is not required, the number of components is also reduced, and thus, it is possible to suppress an increase in the size and weight of the battery device 1A.

It should be noted that, similarly to the fitting recess 25 of the first embodiment, the locking stepped portions 55a and 55a constituted by the engaging portions 55 and 55 in the vertical direction, and the locking stepped portion 56a constituted by the engaging portion 56 in the lateral direction may be constituted by a fitting recess (key groove) for receiving the fastening members 62 and 62.

### EXPLANATION OF REFERENCE NUMERALS

1, 1a battery device

2, 5 battery case

24 opening

25 fitting recess

261 chamfered portion

31 battery cell

4, 6 end plate

4a, 6a long side end face

4b, 6b short side end face

41, 61 recessed groove

42, 62 fastening member

42b end face

421, 621 groove (regulating means)

422, 622 chamfered portion

43, 63 biasing member

44, 64 pin (regulating means)

55, 56 engaging portion

55a, 56a locking stepped portion

1. A fastening structure of an end plate comprising: a battery case that can store a plurality of battery cells in a stacked state; and the end plate that presses the plurality of battery cells in a stacking direction, the fastening structure being configured to fasten the end plate to the battery case, thereby holding the plurality of battery cells in the battery case,
wherein the end plate includes: a recessed groove provided on an end face thereof; a fastening member which is disposed within the recessed groove in a projectable and retractable manner with respect to the end face; and a biasing member that is disposed within the recessed groove and biases the fastening member in a projecting direction,
wherein the battery case includes an engaging portion that engages with the fastening member at a position corresponding to the fastening member of the end plate, and
wherein an engagement of the fastening member of the end plate with the engaging portion allows the end plate to be fastened to the battery case.

2. The fastening structure of the end plate according to claim 1, wherein
the fastening member has a plate shape, and
the engaging portion comprises a fitting recess that receives the fastening member, or a locking stepped portion that locks the fastening member.

3. The fastening structure of the end plate according to claim 1, wherein
the battery case comprises a square tubular-shaped case including a horizontally elongated rectangular opening at both ends thereof in the stacking direction of the plurality of battery cells, and
the end plate is fastened to be fit in the opening of the battery case.

4. The fastening structure of the end plate according to claim 3, wherein
the end plate has a horizontally elongated rectangular plate shape, and includes two long side end faces and two short side end faces, and
the fastening member is disposed on at least one of the two long side end faces, and extends along a length direction of the long side end face.

5. The fastening structure of the end plate according to claim 4, wherein at least one of a side edge of the fastening member close to the battery cell or an inner side edge of the opening has a chamfered portion.

6. The fastening structure of the end plate according to claim 1, wherein the battery case includes a rectangular bottom plate portion, and side plate portions which are provided in a standing manner from four circumferences of the bottom plate portion, and has a bathtub-shape which is only open upward, and
the end plate is fastened on an inner face of the battery case.

7. The fastening structure of the end plate according to claim 6, wherein the end plate has a horizontally elongated rectangular plate shape, and includes two long side end faces and two short side end faces, and
the fastening member includes a plurality of fastening members which are respectively disposed on one of the long side end faces corresponding to the bottom plate portion and two of the short side end faces, and extend along the length directions of the long side end face and the short side end faces.

8. The fastening structure of the end plate according to claims 1, wherein the end plate includes a regulating means that regulates a movement range of the fastening member in a projecting direction.

9. The fastening structure of the end plate according to claim 8, wherein the regulating means is disposed on a side opposite to the battery cell within the battery case with respect to the fastening member.

10. A battery device comprising:
a plurality of battery cells;
a battery case that stores the plurality of battery cells in a stacked state; and
an end plate that is fastened to the battery case, and presses and holds the plurality of battery cells in a stacking direction,
the battery device further comprising the fastening structure of the end plate according to claim 1.
